(19) United States
(12) Patent Application Publication
(10) Pub. No.: US 2021/0160150 A1
(43) Pub. Date: May 27, 2021

(54) INFORMATION PROCESSING DEVICE, INFORMATION PROCESSING METHOD, AND COMPUTER PROGRAM

(71) Applicant: SONY CORPORATION, TOKYO (JP)

(72) Inventors: YUHEI TAKI, KANAGAWA (JP); SOICHIRO INATANI, TOKYO (JP); HIRO IWASE, KANAGAWA (JP); IKUO YAMANO, TOKYO (JP)

(21) Appl. No.: 16/763,541

(22) PCT Filed: Sep. 4, 2018
(86) PCT No.: PCT/JP2018/032748

§ 371 Date: May 12, 2020

(30) Foreign Application Priority Data
Nov. 21, 2017 (JP) 2017-223372

(51) Int. Cl. H04L 12/24; G06F 3/0484; H04W 76/30

(52) U.S. Cl. CPC H04L 41/22; H04W 76/30; G06F 3/0484

(57) ABSTRACT

[Problem] To provide an information processing device, an information processing method, and a computer program that can intuitively present a connection state between wireless appliances in a space. [Solution] An information processing device includes a control unit configured to perform control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

### FIELD

The present disclosure relates to an information processing device, an information processing method, and a computer program.

### BACKGROUND

In recent years, as information processing techniques and communication techniques have been developed, the number and types of appliances that can be connected to the Internet have been remarkably increased. Users have been enabled to access the Internet using such various appliances that can be connected to the Internet, and acquire information or send an instruction from a certain appliance to another appliance. A concept called Internet of Things (IoT) starts to get attention, the IoT for connecting a large number of appliances to exchange information with each other more dynamically and autonomously.

Such an appliance that can be connected to the Internet to transmit or receive information is also called an “IoT device”.

Notably, many products have been caused to be IoT devices, and household electrical appliances such as a television, a refrigerator, an acoustic device, an air conditioning device, and a digital camera that are compatible with the IoT have been developed and widespread.

Regarding increase of such IoT devices, for example, the following Patent Literature 1 discloses an information processing device that can dynamically change an input/output form depending on a situation of the user and adjust output content to solve a problem in that, in a situation in which the user owns a plurality of IoT devices, the user may forget to change a setting and disturb surrounding people by an alarm or a notification sound.

### CITATION LIST

### Patent Literature

Patent Literature 1: JP 2016-091221 A

### SUMMARY

### Technical Problem

However, to check which object present in the periphery is the IoT device, a current connection state of the IoT device present in the periphery, or the like, a dedicated GUI screen is required to be called, so that time and effort are taken for operation.

The present disclosure provides an information processing device, an information processing method, and a computer program that can intuitively present a connection state of a wireless appliance in a space.

### Solution to Problem

According to the present disclosure, an information processing device is provided that includes: a control unit that performs control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

According to the present disclosure, an information processing method performed by a processor, the information processing method is provided that includes: performing control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

According to the present disclosure, a computer program is provided that causes a computer to function as a control unit that performs control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

### Advantageous Effects of Invention

As described above, according to the present disclosure, the connection state of the wireless appliance in the space can be intuitively presented.

The effects described above are not necessarily limiting, and any one of the effects described in the present description or another effect that may be grasped from the present description may be exhibited in addition to or in place of the effects described above.

### BRIEF DESCRIPTION OF DRAWINGS

FIG. 1 is a diagram for explaining an outline of an information processing system according to one embodiment of the present disclosure.

FIG. 2 is a diagram for explaining an example of an information processing terminal according to one embodiment of the present disclosure.

FIG. 3 is a block diagram illustrating an example of a configuration of the information processing terminal according to the present embodiment.

FIG. 4 is a flowchart illustrating operation processing related to display of a connection state of the information processing terminal according to the present embodiment.

FIG. 5 is a diagram illustrating an example of an activation gesture for AR cable display according to the present embodiment.

FIG. 6 is a diagram illustrating an example of AR cable display according to the present embodiment.

FIG. 7 is a diagram illustrating another example of AR cable display according to the present embodiment.

FIG. 8 is a diagram illustrating an example of a connection gesture according to the present embodiment.

FIG. 9 is a diagram illustrating another example of the connection gesture according to the present embodiment.

FIG. 10 is a diagram for explaining an example of a display mode of an AR cable image according to the present embodiment.

FIG. 11 is a diagram for explaining another example of the display mode of the AR cable image according to the present embodiment.

FIG. 12 is a diagram for explaining filtering of a connection destination at the time of starting a connection operation according to the present embodiment.

FIG. 13 is a diagram illustrating an example of a disconnection gesture according to the present embodiment.

FIG. 14 is a diagram illustrating another example of the disconnection gesture according to the present embodiment.

FIG. 15 is a block diagram illustrating a hardware configuration example of the information processing terminal according to one embodiment of the present disclosure.

### DESCRIPTION OF EMBODIMENTS

The following describes a preferred embodiment of the present disclosure in detail with reference to the attached drawings. In the present description and the drawings, constituent elements having substantially the same functional configuration are denoted by the same reference numerals, and redundant description will not be repeated.

Description will be made in the following order.

1. Outline of information processing system according to one embodiment of present disclosure

2. Configuration of information processing terminal

3. Operation processing

4. Complement
(4-1. Application example)
(4-2. Hardware configuration)

5. Conclusion

### 1. OUTLINE OF INFORMATION PROCESSING SYSTEM ACCORDING TO ONE EMBODIMENT OF PRESENT DISCLOSURE

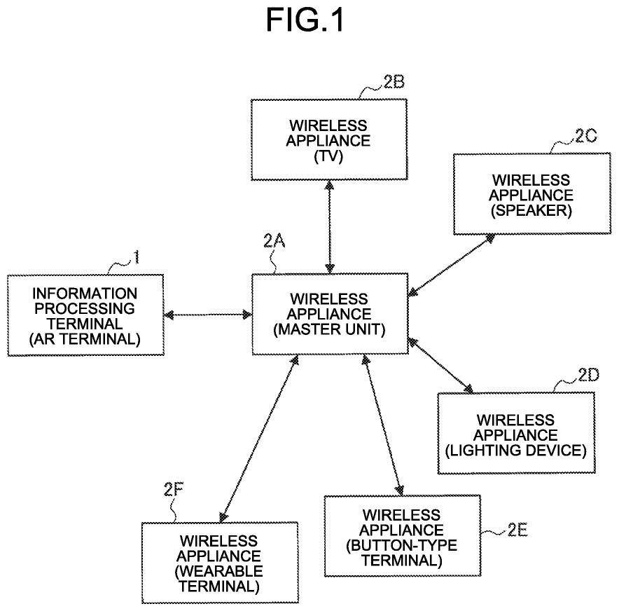

FIG. 1 is a diagram for explaining an outline of an information processing system according to one embodiment of the present disclosure. As illustrated in FIG. 1, the information processing system according to the present embodiment includes an information processing terminal 1 and wireless appliances 2 (wireless appliances 2A to 2F). All of the information processing terminal 1 and the wireless appliances 2A to 2F are devices that can perform wireless communication.

### BACKGROUND

As described above, in recent years, various objects present in the periphery have been enabled to be connected to the Internet due to an IoT technique. For example, in addition to a mobile device such as a smartphone, a tablet, or a notebook personal computer (PC), and a wearable device such as a head mounted display (HMD), smart eyeglasses, a smart band, smart earphones, and a smart necklace, consumer electronics (CE) devices such as a television, a recorder, a digital camera, a game machine, an air conditioner, an acoustic device, a lighting device, a refrigerator, a washing machine, a microwave oven, a home projector, or a desktop PC have been enabled to be connected to the Internet to transmit, receive, or control data.

In recent years, a smart home, which is obtained by causing a house to be compatible with IoT, starts to be implemented, and IoT products that can be connected to the Internet have become widespread.

However, while various products used in daily life are caused to be compatible with the IoT and connected to the Internet or a home network to improve convenience as described above, IoT products are required to be frequently connected, disconnected, changed, or the like, and a burden is imposed on users. On a dedicated graphical user interface (GUI) screen at the time of making a wireless communication connection and the like, IDs of wireless appliances are often displayed in a list format, so that association between a real object (IoT product) and the ID is unclear, and it is difficult for a general user to identify the association therebetween at a glance.

Due to difficulty in operability for wireless connection or disconnection, opportunity loss and useless user operations have been caused.

Thus, the information processing system according to the present embodiment enables the user to intuitively grasp a connection state by displaying a virtual object indicating the connection state between wireless appliances present in a space based on positions of the wireless appliances. The information processing system according to the present embodiment also enables usability to be improved by enabling connection or disconnection of the wireless appliance to be controlled by an intuitive operation such as a gesture operation.

Specifically, as illustrated in FIG. 1 for example, in a system configuration including the information processing terminal 1 owned by the user and the wireless appliances 2A to 2F, the information processing terminal 1 receives, from the wireless appliance 2A, connection information about a connection between the wireless appliance 2A and the other wireless appliances 2B to 2F, and recognizes three-dimensional positions of the respective wireless appliances 2A to 2F in a real space. The connection information may be included in wireless information (Wi-Fi wireless information and the like) sent from the wireless appliance 2A, for example, or may be acquired from the information processing terminal 1 by request after the wireless appliance 2A is connected to the information processing terminal 1 for communication.

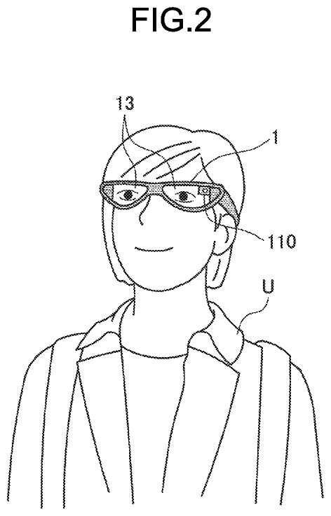

The information processing terminal 1 owned by the user and the wireless appliances 2A to 2F are present in the same space (for example, in the same room), for example. The information processing terminal 1 may be what is called an augmented reality (AR) terminal that performs control for displaying a virtual object on a transmissive display unit to seem to be imposed on the real space, and implements augmented reality. With reference to FIG. 2, the following describes an AR terminal as an example of the information processing terminal 1.

As illustrated in FIG. 2, the AR terminal may be a spectacle-type wearable terminal, for example. As illustrated in FIG. 2, the information processing terminal 1 according to the present embodiment is implemented by a spectacle-type head mounted display (HMD) worn by a user U on his/her head part, for example. Display units 13 corresponding to spectacle lens portions that are positioned in front of eyes of the user U at the time of wearing may be a transmissive type or a non-transmissive type. By displaying a virtual object on the display units 13, the information processing terminal 1 can present the virtual object in a field of vision of the user U. The HMD as an example of the information processing terminal 1 is not limited to the HMD that presents an image to both eyes, but may be an HMD that presents an image to only one eye. For example, the HMD may be a monocular type in which the display unit 13 that presents an image to one eye is disposed.

The information processing terminal 1 also includes an outward camera 110 disposed therein that images a sight line direction of the user U at the time of wearing, that is, the field of vision of the user. Additionally, although not illustrated in FIG. 1, various sensors such as an inward camera that images the eyes of the user U at the time of wearing and a microphone (hereinafter, referred to as a “microphone”) may also be disposed in the information processing terminal 1. A plurality of the outward cameras 110 and the inward cameras may be disposed.

The shape of the information processing terminal 1 is not limited to the example illustrated in FIG. 1. For example, the information processing terminal 1 may be an HMD of a headband type (a type that is worn with a band surrounding the entire circumference of the head part. A band may be disposed to pass through not only a side of the head part but also the top of the head part), or an HMD of a helmet type (a visor portion of a helmet corresponds to a display). Alternatively, the information processing terminal 1 may be implemented by a wearable device such as a wristband type (for example, a smart watch; including a case with a display or without a display), a headphone type (not including a display), or a neckphone type (a neck-hanging type; including a case with a display or without a display).

The following describes the wireless appliances 2A to 2F. The wireless appliances 2A to 2F are IoT devices that can perform wireless communication, and assumed to be various appliances. By way of example, the wireless appliance 2A is a Wi-Fi (registered trademark) master unit, the wireless appliance 2B is a television apparatus, the wireless appliance 2C is a speaker, the wireless appliance 2D is a lighting device, the wireless appliance 2E is a button-type terminal, and the wireless appliance 2F is a wearable terminal. The wireless appliance 2A is a communication appliance that is connected to the peripheral wireless appliances 2B to 2F for communication, and relays communication with the Internet or a home network. The button-type terminal is, for example, a terminal dedicated to order in Internet shopping with which a predetermined commodity can be automatically purchased by pushing a button disposed on the terminal, for example.

The information processing terminal 1 can enable the user to intuitively grasp the connection state of the wireless appliance 2 by AR-displaying a virtual object indicating a link between the wireless appliance 2A and the other wireless appliances 2B to 2F in accordance with three-dimensional positions of the wireless appliances present in the space based on the connection information received from the wireless appliance 2A.

The information processing system according to one embodiment of the present disclosure has been described above. The following describes a specific configuration of the information processing terminal included in the information processing system according to the present embodiment with reference to the drawings.

### 2. CONFIGURATION OF INFORMATION PROCESSING TERMINAL 1

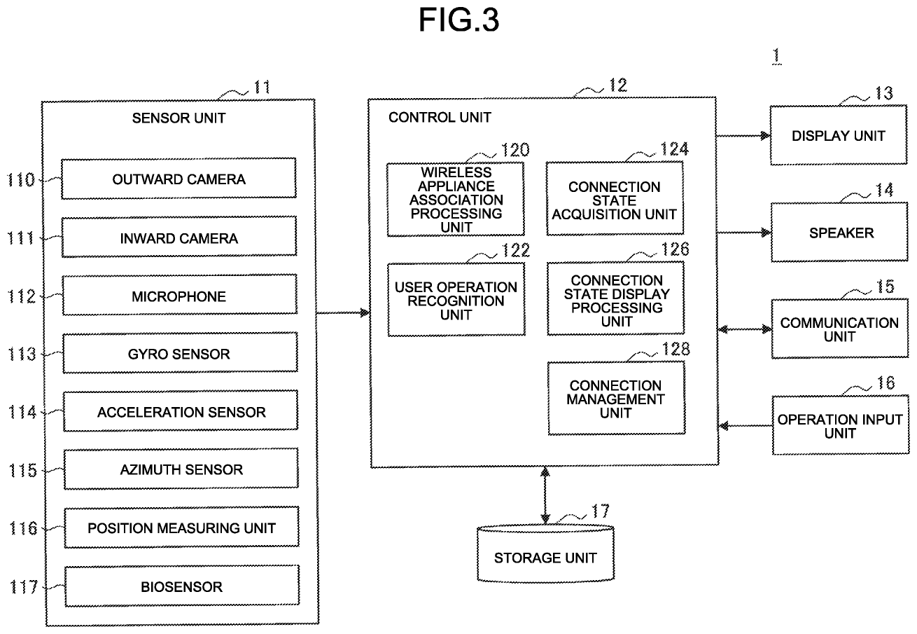

FIG. 3 is a block diagram illustrating an example of a configuration of the information processing terminal 1 according to the present embodiment. As illustrated in FIG. 3, the information processing terminal 1 includes a sensor unit 11, a control unit 12, a display unit 13, a speaker 14, a communication unit 15, an operation input unit 16, and a storage unit 17.

(Sensor Unit 11)

The sensor unit 11 has a function of acquiring various kinds of information about the user or a peripheral environment. For example, the sensor unit 11 includes an outward camera 110, an inward camera 111, a microphone 112, a gyro sensor 113, an acceleration sensor 114, an azimuth sensor 115, a position measuring unit 116, and a biosensor 117. A specific example of the sensor unit 11 described herein is merely an example, and the present embodiment is not limited thereto. The number of the respective sensors may be plural.

The specific example of the sensor unit 11 illustrated in FIG. 3 is exemplified as a preferred example, but all components thereof are not necessarily provided. For example, the sensor unit 11 may have a configuration including part of the specific example of the sensor unit 11 illustrated in FIG. 3 such as a configuration including only the outward camera 110, the acceleration sensor 114, and the position measuring unit 116, or may further include another sensor.

Each of the outward camera 110 and the inward camera 111 includes a lens system constituted of an imaging lens, a diaphragm, a zoom lens, a focus lens, and the like, a driving system that causes the lens system to perform a focus operation and a zoom operation, a solid-state imaging element array that performs photoelectric conversion on imaging light obtained by the lens system to generate an imaging signal, and the like. The solid-state imaging element array may be implemented, for example, by a charge coupled device (CCD) sensor array or a complementary metal oxide semiconductor (CMOS) sensor array.

In the present embodiment, an angle of view and orientation of the outward camera 110 are preferably set to image a region corresponding to a field of vision of the user in the real space.

The microphone 112 collects a voice of the user and a surrounding environmental sound to be output to the control unit 12 as voice data.

The gyro sensor 113 is, for example, implemented by a triaxial gyro sensor, and detects an angular speed (rotational speed).

The acceleration sensor 114 is, for example, implemented by a triaxial acceleration sensor (also referred to as a G sensor), and detects acceleration at the time of movement.

The azimuth sensor 115 is, for example, implemented by a triaxial geomagnetic sensor (compass), and detects an absolute direction (azimuth).

The position measuring unit 116 has a function of detecting a current position of the information processing terminal 1 based on a signal acquired from the outside. Specifically, for example, the position measuring unit 116 is implemented by a Global Positioning System (GPS) measuring unit, and receives radio waves from GPS satellites, detects a position at which the information processing terminal 1 is present, and outputs the detected positional information to the control unit 12. The position measuring unit 116 may also detect the position via Wi-Fi (registered trademark), Bluetooth (registered trademark), transmission/reception to/from a cellular telephone, a PHS, a smartphone, and the like, short-range communication, or the like in addition to the GPS, for example.

The biosensor 117 detects biological information of the user. Specifically, for example, the biosensor 117 may detect a heartbeat, a body temperature, sweating, a blood pressure, sweating, a pulse, respiration, nictitation, an eye movement, a gazing time, a size of pupil diameter, a blood pressure, brain waves, a body motion, a posture, a skin temperature, electric skin resistance, micro vibration (MV), myoelectric potential, blood oxygen saturation (SPO2), or the like.

(Control Unit 12)

The control unit 12 functions as an arithmetic processing unit and a control device, and controls the entire operations in the information processing terminal 1 in accordance with various computer programs. The control unit 12 may be implemented by an electronic circuit such as a central processing unit (CPU) and a microprocessor, for example. The control unit 12 may also include a read only memory (ROM) that stores a computer program to be used, an arithmetic parameter, and the like, and a random access memory (RAM) that temporarily stores a parameter and the like that vary as appropriate.

The control unit 12 according to the present embodiment controls starting or stopping of each configuration, for example. The control unit 12 can also input a control signal to the display unit 13 or the speaker 14. As illustrated in FIG. 3, the control unit 12 according to the present embodiment may also function as a wireless appliance association processing unit 120, a user operation recognition unit 122, a connection state acquisition unit 124, a connection state display processing unit 126, and a connection management unit 128.

Wireless Appliance Association Processing Unit 120

The wireless appliance association processing unit 120 acquires three-dimensional position information of the wireless appliance present in the space based on the information acquired by the sensor unit 11 or the communication unit 15, and associates the three-dimensional position information with wireless information (for example, Wi-Fi wireless information).

For example, the wireless appliance association processing unit 120 analyzes a taken image sensed by the sensor unit 11 to recognize an object, and acquires the three-dimensional position of the wireless appliance. Subsequently, the wireless appliance association processing unit 120 specifies the wireless appliance in the space based on the device specification information that is received from the wireless appliance via the communication unit 15, and associates the wireless appliance with the wireless information. The device specification information is included in the wireless information, and includes information about a physical characteristic of a corresponding wireless appliance (a characteristic amount, image information, and the like), for example. The wireless appliance association processing unit 120 can specify the wireless appliance in the space by comparing an object recognition result with characteristic information. The control unit 12 of the information processing terminal 1 may recognize a three-dimensional space in advance by using a Simultaneously Localization and Mapping (SLAM) technique, and recognize three-dimensional position information of real objects in the periphery.

For example, the wireless appliance association processing unit 120 analyzes the taken image taken by an AR camera included in the sensor unit 11, and detects an AR marker given to the wireless appliance to acquire the three-dimensional position. The wireless information acquired by the communication unit 15 includes AR marker information, and the wireless appliance association processing unit 120 can associate the wireless information with the wireless appliance recognized (the position of which is specified) in the space by performing comparison with the AR marker information.

Alternatively, for example, the wireless appliance association processing unit 120 may analyze the taken image taken by the camera included in the sensor unit 11, detects a QR code (registered trademark) given to the wireless appliance to acquire the three-dimensional position, and compares the three-dimensional position with the wireless information received from the communication unit 15 to make association therebetween.

For example, the wireless appliance association processing unit 120 may also analyze a specific image, a sound, or blinking of an LED, an infrared LED, an ultraviolet LED, and the like emitted from the wireless appliance detected by a camera, a microphone, a light receiving unit, and the like included in the sensor unit 11 to specify the three-dimensional position of the wireless appliance, and associate the three-dimensional position with the wireless information received from the communication unit 15. The wireless information includes, for example, image information, sound information, or blinking information, which can be compared with an analysis result by the wireless appliance association processing unit 120.

User Operation Recognition Unit 122

The user operation recognition unit 122 performs processing of recognizing a user operation using various kinds of sensor information sensed by the sensor unit 11. For example, the user operation recognition unit 122 can recognize a gesture of the user based on a taken image, depth information, positional information, motion information, and the like sensed by the sensor unit 11. The user operation recognition unit 122 can also recognize a request from the user by performing voice recognition based on an utterance of the user sensed by the sensor unit 11.

The user operation recognition unit 122 can also detect a user operation of managing a connection between the wireless appliances. The user operation of managing a connection is a connection operation of connecting the wireless appliances, and a disconnection operation of disconnecting the connection between the wireless appliances. For example, the user operation recognition unit 122 specifies the wireless appliance designated by the user based on various kinds of sensor information sensed by the sensor unit 11, and based on a position of a hand or content of uttered voice of the user. Additionally, the user operation recognition unit 122 recognizes the wireless appliance instructed to be connected or disconnected by the operation based on a motion of the hand, a shape of a finger, or content of the uttered voice of the user. The user operation may be a combination of a gesture and a voice.

Connection State Acquisition Unit 124

The connection state acquisition unit 124 acquires information about the connection state between the wireless appliances based on the connection information that is received from the wireless appliance 2A via the communication unit 15. For example, the connection state acquisition unit 124 acquires information indicating that which of the wireless appliances 2n is connected to the wireless appliance 2A based on the received connection information, and in a case of the connected state, and what is a communication scheme (Bluetooth, Wi-Fi, short-range communication, ZigBee (registered trademark), or the like), and band utilization setting information (restricted/unrestricted), and the like.

Connection State Display Processing Unit 126

The connection state display processing unit 126 performs control for displaying a virtual object indicating a link between the wireless appliances (indicating the connected state) on the display unit 13 based on connection state information between the wireless appliances acquired by the connection state acquisition unit 124 and three-dimensional position information of a corresponding wireless appliance acquired by the wireless appliance association processing unit 120. The virtual object indicating the connected state between the wireless appliances may be an AR image connecting the wireless appliances using a line, for example, an image of a virtual cable.

The connection state display processing unit 126 can perform not only control for displaying the virtual object indicating the connected state but also control for displaying a virtual object indicating a disconnected state for the wireless appliance 2n that is not connected to the wireless appliance 2A in a wireless manner, for example. Which wireless appliance is in the disconnected state can be determined by the information processing terminal 1 by referring to wireless information received from the wireless appliance 2 in the periphery.

The connection state display processing unit 126 may also control a motion of the virtual object to be displayed in accordance with the connection operation or the disconnection operation performed by the user that is recognized by the user operation recognition unit 122.

Connection Management Unit 128

The connection management unit 128 performs connection management (connection, disconnection, and the like) of a target wireless appliance in accordance with the user operation recognized by the user operation recognition unit 122.

Specifically, for example, the connection management unit 128 transmits, to the wireless appliance 2A (in this case, Wi-Fi), a control signal for instructing to connect or disconnect the connection between the wireless appliance 2A and the wireless appliance 2n designated by the user. The connection management unit 128 may transmit the control signal to the wireless appliance 2n side that is connected/disconnected to/from the master unit.

(Display Unit 13)

The display unit 13 is, for example, implemented by a lens unit (an example of a transmissive display unit) that performs display using a hologram optical technique, a liquid crystal display (LCD) device, an organic light emitting diode (OLED) device, and the like. The display unit 13 may be a transmissive type, a transflective type, or a non-transmissive type.

(Speaker 14)

The speaker 14 reproduces a voice signal in accordance with control by the control unit 12.

(Communication Unit 15)

The communication unit 15 is a communication module for transmitting/receiving data to/from another device in a wired/wireless manner. For example, the communication unit 15 wirelessly communicates with an external apparatus directly or via a network access point using a scheme such as a wired local area network (LAN), a wireless LAN, Wireless Fidelity (Wi-Fi, registered trademark), infrared communication, Bluetooth registered trademark), short distance/non-contact communication, and a portable communication network (Long Term Evolution (LTE), third-generation mobile object communication scheme (3G)).

(Operation Input Unit 16)

The operation input unit 16 is implemented by an operation member having a physical structure such as a switch, button, or a lever.

(Storage Unit 17)

The storage unit 17 is implemented by a read only memory (ROM) that stores a computer program, an arithmetic parameter, and the like used for the processing performed by the control unit 12 described above, and a random access memory (RAM) that temporarily stores a parameter and the like that vary as appropriate. The storage unit 17 according to the present embodiment may store various kinds of sensor information, a recognition result, and connection information, for example.

The configuration of the information processing terminal 1 according to the present embodiment has been specifically described above. The configuration that has been described above with reference to FIG. 3 is merely an example, and the functional configuration of the information processing terminal 1 according to the present embodiment is not limited thereto.

For example, the information processing terminal 1 according to the present embodiment does not necessarily include the entire configuration illustrated in FIG. 3. The information processing terminal 1 may have a configuration not including the inward camera 111 or the biosensor 117, for example. The information processing terminal 1 may be constituted of a plurality of devices. For example, the information processing terminal 1 may be constituted of a spectacle-type wearable terminal worn by the user, a wearable terminal such as a smart band, and a smartphone. At least part of the sensor unit 11 may be a surrounding environmental sensor (for example, a surveillance camera, a microphone, an infrared sensor, an ultrasonic sensor, and the like disposed in a room).

For example, at least part of the function of the control unit 12 of the information processing terminal 1 may be present in another device that is connected thereto for communication via the communication unit 15. For example, at least part of the function of the control unit 12 of the information processing terminal 1 may be provided to an intermediate server, a cloud server on the Internet, or the like. Alternatively, the configuration may be such that a level of processing performed by the control unit 12 is caused to be simple, and high-level processing is performed by an external device, for example, another mobile device such as a smartphone owned by the user, a home server, an edge server, an intermediate server, or a cloud server. By distributing the processing to a plurality of devices, a load can be reduced. By performing processing in the information processing terminal 1 or by an external device (for example, another mobile device, a home server, an edge server, and the like) having a communication distance relatively close to the information processing terminal 1, real-time performance can be improved and security can be secured.

The functional configuration of the information processing terminal 1 according to the present embodiment can be flexibly modified in accordance with specifications and operations.

### 3. OPERATION PROCESSING

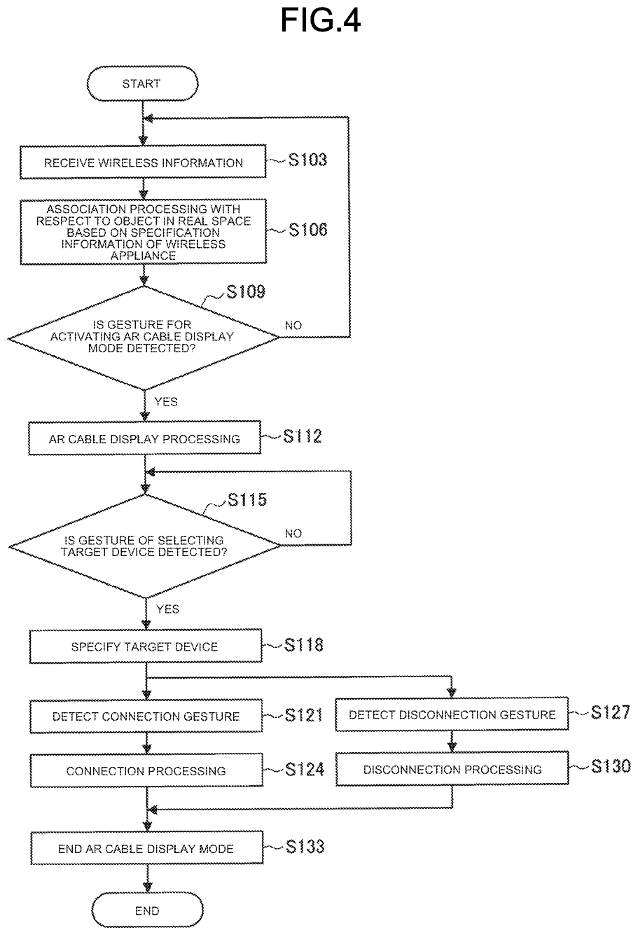

The following specifically describes operation processing performed by the information processing system according to the present embodiment with reference to FIG. 4.

FIG. 4 is a flowchart illustrating operation processing related to display of the connection state of the information processing terminal 1 according to the present embodiment. As illustrated in FIG. 4, first, the information processing terminal 1 receives the wireless information from one or more wireless appliances 2 in the periphery (Step S103).

Next, the wireless appliance association processing unit 120 of the information processing terminal 1 performs association processing with respect to an object in the real space (that is, the wireless appliance present in the space) based on specification information of the wireless appliance (Step S106).

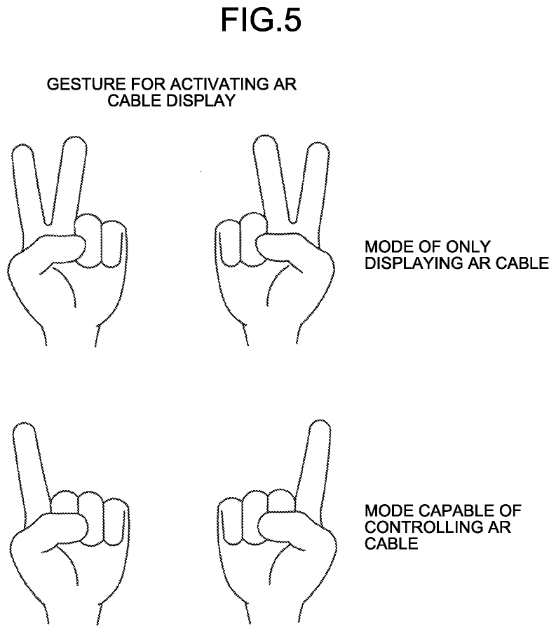

Subsequently, the information processing terminal 1 determines whether a gesture of activating (starting) display of the connection state is detected (Step S109). In the present embodiment, for example, an image of a virtual cable is used as the virtual object indicating the connection state, so that a “mode of displaying the connection state” is referred to as an “AR cable display mode” hereinafter. FIG. 5 illustrates an example of an activation gesture for AR cable display.

As illustrated in FIG. 5, for example, a gesture of raising fingers of both hands of the user may be set as the activation gesture for the AR cable display mode. The display mode can be switched depending on the number of raised fingers. For example, as illustrated in an upper row of FIG. 5, a gesture of raising two fingers of both hands may be assumed to be a mode of only displaying the AR cable (a mode in which control such as connection or disconnection cannot be performed), and as illustrated in a lower row of FIG. 5, a gesture of raising one finger of both hands may be assumed to be an AR cable controllable mode (a mode in which control such as connection or disconnection can be performed). A display activating (starting) operation for the AR cable is not limited to such gestures, and may be a voice command (uttering a keyword such as “AR cable” or “wireless control”), or may be an external trigger. The external trigger may be, for example, a case in which the information processing terminal 1 receives a connection request, a case in which the information processing terminal 1 finds a new device (wireless appliance), and the like. The connection request is transmitted from the Wi-Fi master unit to the information processing terminal 1 of the user having connection authority in a case in which another user tries to connect a wireless appliance to the Wi-Fi master unit, for example. The display activating (starting) operation for the AR cable may be a combination of a gesture and a voice command for preventing a malfunction and the like.

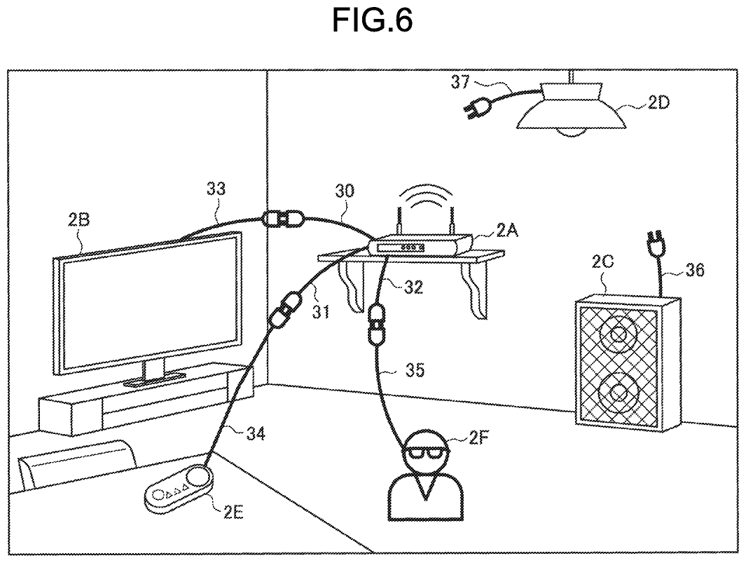

Next, in a case of detecting an activation gesture for AR cable display (Yes at Step S109), the connection state display processing unit 126 of the information processing terminal 1 performs display processing of the AR cable (Step S112). Specifically, the information processing terminal 1 acquires the connection information via the connection state acquisition unit 124, refers to the positional information acquired by the wireless appliance association processing unit 120, and displays the AR cable that links the wireless appliances in the connected state with each other on the display unit 13 so that the connection state of the wireless appliances present in the real space can be visually grasped. FIG. 6 illustrates an example of AR cable display.

As illustrated in FIG. 6, on the transmissive display unit 13, the wireless appliance 2A (real object) and the wireless appliance 2B (real object) in the connected state are linked to each other via AR cable images 30 and 33. The wireless appliance 2A (real object) and the wireless appliance 2E (real object) in the connected state are linked to each other via AR cable images 31 and 34. The wireless appliance 2A (real object) and the wireless appliance 2F (which is a wearable device worn by another user present outside the field of vision, so that it is replaced with an icon image herein) in the connected state are linked to each other via AR cable images 32 and 35. The wireless appliance 2F may be a wearable terminal (information processing terminal 1) worn by the user himself/herself. That is, the icon image of a person illustrated in FIG. 6 may be displayed to be a face image or an avatar image of the user, and the connection state between the wearable terminal (information processing terminal 1) of the user and the other wireless appliance 2 may be intuitively represented using the AR cable image.

Furthermore, as illustrated in FIG. 6, by displaying AR cable images 37 and 36 in a state of being not linked to any wireless appliance at positions of the wireless appliances 2C and 2D (real objects) in a state of being disconnected from the other wireless appliances, it is possible to enable the user to grasp the fact that the wireless appliances 2C and 2D can be connected to the other wireless appliance but are currently in the disconnected state (non-connected state).

In this way, in the present embodiment, by displaying the AR cable image corresponding to the position of the wireless appliance as the real object, the user is enabled to intuitively grasp which real object is the wireless appliance, and grasp a current connection state.

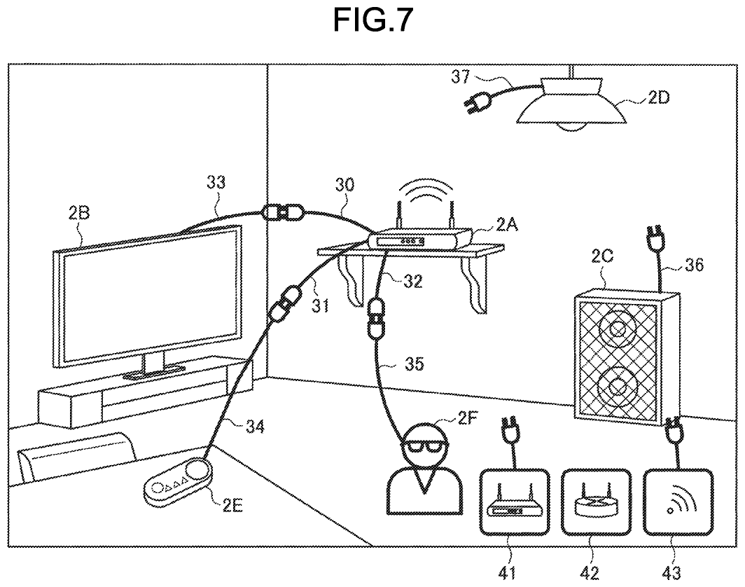

With the information processing system according to the present embodiment, it is possible to display a wireless appliance present in another space (for example, another room) as an icon image and the like, and display the connection state thereof with respect to the wireless appliance present in the real space using the AR cable image in a similar manner. FIG. 7 illustrates another example of AR cable display. As illustrated in FIG. 7, icon images 41, 42, and 43 of connectable wireless appliances present in another room may be displayed based on the wireless information of the connectable wireless appliances present in the other room and the connection information received from the wireless appliance 2A, for example, and the AR cable image may be further displayed to clearly indicate the connection state.

Subsequently, the information processing terminal 1 determines whether a gesture of selecting a target device is detected (Step S115). The target device is a wireless appliance as a target on which the user performs connection management control. The user can hold his/her hand near the wireless appliance 2 (real object) as the target to select the target device based on a predetermined motion of the hand or a predetermined shape of a finger, for example. The information processing terminal 1 may specify the wireless appliance 2 (real object) in front of the user's hand based on analysis of the taken image corresponding to the field of vision of the user that is taken by the outward camera 110 and acquired from the sensor unit 11, the line of sight of the user acquired by the inward camera 111, and orientation of a head of the user acquired by the gyro sensor 113, the acceleration sensor 114, the azimuth sensor 115, or the like.

Next, after specifying the target device (Step S118), the information processing terminal 1 detects a connection gesture (Step S121), or detects a disconnection gesture (Step S127). Gestures from selecting to connecting/disconnecting the target device may be detected as a series of gestures. Operations of selecting and connecting/disconnecting the target device may be performed by a voice command, or a combination of a gesture and a voice command.

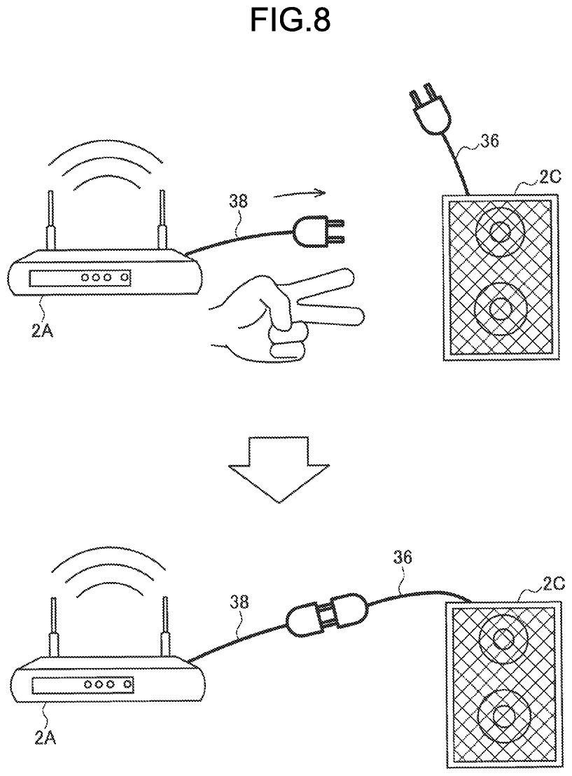

Subsequently, the information processing terminal 1 performs connection processing in a case of detecting the connection gesture (Step S124), and performs disconnection processing in a case of detecting the disconnection gesture (Step S130). The following describes a specific example of the connection/disconnection gesture with reference to FIG. 8 to FIG. 14.

(Connection Gesture)

FIG. 8 is a diagram illustrating an example of the connection gesture according to the present embodiment. As illustrated in FIG. 8, for example, the connection gesture may be a gesture of holding two fingers near the wireless appliance 2A as a target device of the connection operation to start to move, and moving to the position of the wireless appliance 2C. At the time when the user holds his/her two fingers near the wireless appliance 2A and starts to move, the information processing terminal 1 performs display processing of pulling out an AR cable image 38 from the wireless appliance 2A, and extending the AR cable image 38 following a motion of the hand of the user. In a case in which the hand of the user stops at the position of the wireless appliance 2C, the information processing terminal 1 performs processing of connecting the wireless appliance 2A with the wireless appliance 2C.

The connection operation may be commanded by indicating a name of the wireless appliance to be connected by a voice command, for example, an uttered voice such as “connect the Wi-Fi master unit with the speaker” or “connect the Wi-Fi master unit with the speaker by Bluetooth (BT)”. The name of the wireless appliance may be associated with the real object by the wireless appliance association processing unit 120. The connection operation may be a combination of a gesture and a voice command. For example, in a case in which the user shows his/her two fingers and utters the voice command such as “connect the Wi-Fi master unit with the speaker”, the information processing terminal 1 performs wireless connection processing of the Wi-Fi master unit and the speaker.

After performing the connection processing, as illustrated in a lower row of FIG. 8, the information processing terminal 1 displays the AR cable image 38 of the wireless appliance 2A and the AR cable image 36 of the wireless appliance 2C to be linked to each other. Due to this, the user can intuitively grasp the fact that the connection processing ends. In a case in which it takes much time for the connection processing, the information processing terminal 1 may display text such as “connecting”, an icon image indicating a connecting state, and the like in the vicinity of the AR cable images 36 and 38. The information processing terminal 1 may also generate a sound, vibration, an image, blinking, and the like as feedback at the time when the connection operation is detected or connection is completed.

The information processing terminal 1 may perform processing of connecting a plurality of the wireless appliances to the other wireless appliance by one connection gesture operation performed by the user. For example, in a case in which a plurality of the button-type terminals (wireless appliances 2E) are present in the space, it may be troublesome to connect the button-type terminals to the Wi-Fi master unit (wireless appliance 2A) one by one by gesture. Thus, in a case in which the button-type terminals are detected, and the user designates one of the button-type terminals and performs the connection gesture operation thereon with respect to the Wi-Fi master unit, the information processing terminal 1 can perform control for connecting the other button-type terminals present in the same space to be connected to the Wi-Fi master unit, and save time and effort of the user.

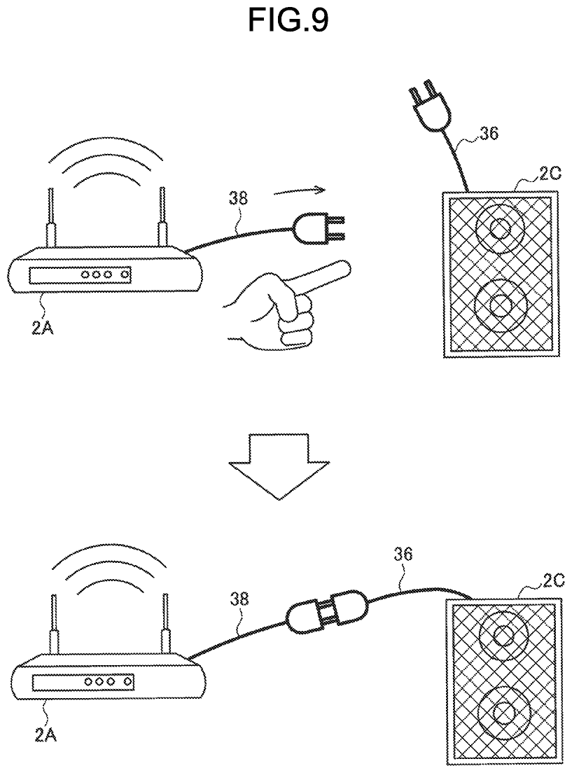

It is also possible to select a communication scheme and performs band utilization setting depending on a type of the connection gesture. For example, the information processing terminal 1 may perform a Wi-Fi connection in a case of the connection gesture using two fingers illustrated in FIG. 8, and may perform a Bluetooth connection in a case of the connection gesture using one finger illustrated in FIG. 9.

At the time of performing the connection operation by combining a gesture and a voice command, the communication scheme may be enabled to be selected depending on a motion of the hand, the shape of the finger, and the like. For example, in a case in which the user shows his/her two fingers and utters a voice command such as “connect the AR terminal with the speaker”, the information processing terminal 1 may perform Wi-Fi communication connection processing of the AR terminal (in this case, the information processing terminal 1 worn by the user himself/herself) and the speaker, and in a case in which the user shows his/her one finger and utters a voice command such as “connect the AR terminal with the speaker”, the information processing terminal 1 may perform BT communication connection processing of the AR terminal and the speaker.

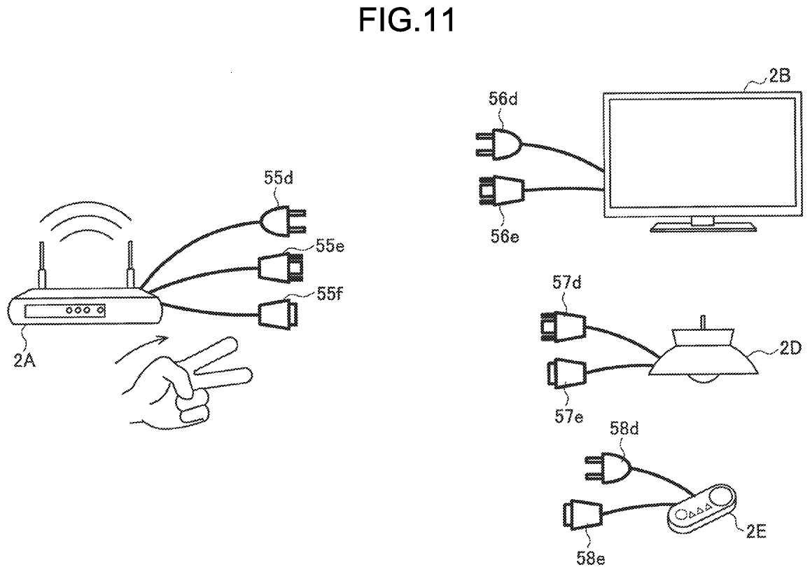

The information processing terminal 1 may classify display modes of the AR cable image depending on the type of the communication scheme and the like so that the user can intuitively grasp the type of the communication scheme and the like. FIG. 11 is a diagram illustrating an example of the display mode of the AR cable image according to the present embodiment.

As illustrated in FIG. 11, for example, at the time when the user holds his/her hand near the wireless appliance 2A to start the connection gesture, the information processing terminal 1 may display AR cable images 55a to 55c having different colors depending on the type of the communication scheme that can be utilized by the wireless appliance 2A. For example, the AR cable image 55a corresponds to a first communication scheme (for example, Wi-Fi), the AR cable image 55b corresponds to a second communication scheme (for example, Bluetooth), and the AR cable image 55c corresponds to a third communication scheme (for example, short-range wireless communication). At this point, the information processing terminal 1 also pulls out AR cable images 56a, 56b, 57a, 57b, 58a, and 58b having different colors depending on a type of an available communication scheme from the other wireless appliances 2B, 2D, and 2E to be displayed. Due to this, the user can intuitively and visually grasp the wireless appliance that can be connected and the communication scheme that can be used therefor.

The display mode of the AR cable image corresponding to the type of the communication scheme is represented not only by a difference in color but also by a difference in a shape of a plug (a distal end portion of the AR cable) as illustrated in FIG. 11, for example. In the example illustrated in FIG. 11, at the time when the user holds his/her hand near the wireless appliance 2A to start the connection gesture, the information processing terminal 1 similarly displays AR cable images 55d to 55e having different plug shapes depending on the type of the communication scheme that can be utilized by the wireless appliance 2A. For example, the AR cable image 55d corresponds to the first communication scheme (for example, Wi-Fi), the AR cable image 55e corresponds to the second communication scheme (for example, Bluetooth), and the AR cable image 55f corresponds to the third communication scheme (for example, short-range wireless communication). At this point, the information processing terminal 1 also pulls out AR cable images 56d, 56e, 57d, 57e, 58d, and 58e having different plug shapes depending on the type of the available communication scheme from the other wireless appliances 2B, 2D, and 2E to be displayed. Due to this, the user can intuitively and visually grasp the wireless appliance that can be connected and the communication scheme that can be used therefor.

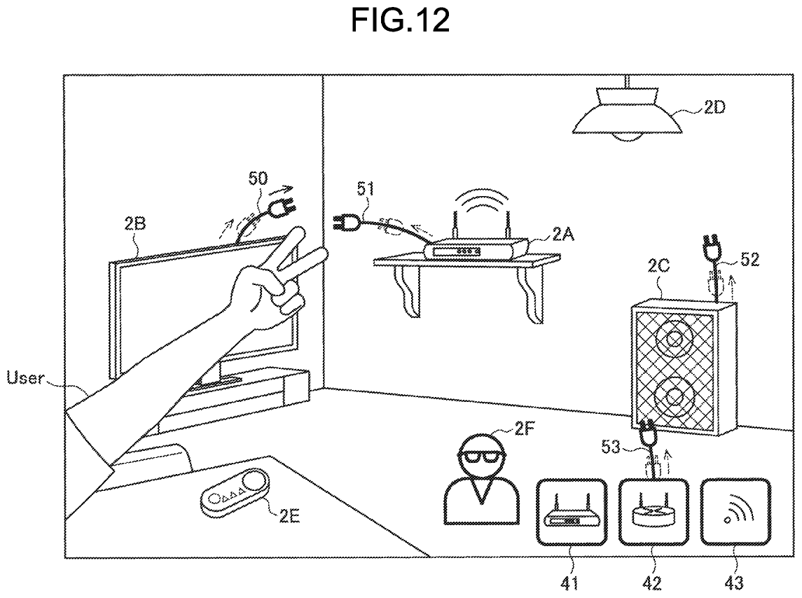

Next, the following describes filtering of a connection destination at the time when the connection gesture operation is performed with reference to FIG. 12. FIG. 12 is a diagram for explaining filtering of the connection destination at the time of starting the connection operation according to the present embodiment.

As illustrated in FIG. 12, for example, when the user starts the connection gesture operation, all of the AR cable images (the AR cables 30 to 37 indicating the connection state illustrated in FIG. 6 and FIG. 7) temporarily disappear, and AR cable images 51 and 52 of the wireless appliances 2A and 2C that can be connected to the wireless appliance 2B as an operation target, and an AR cable image 53 of the wireless appliance that is present in another room but can be connected to the wireless appliance 2B appear thereafter. By filtering the AR cable image of the connection destination in this way, the user can intuitively grasp the wireless appliance 2n to which the wireless appliance 2B that is currently designated can be connected.

In the filtering of the connection destination, only the AR cable image of the wireless appliance 2n that is allowed to be connection-controlled by the user may be displayed based on authority of the user.

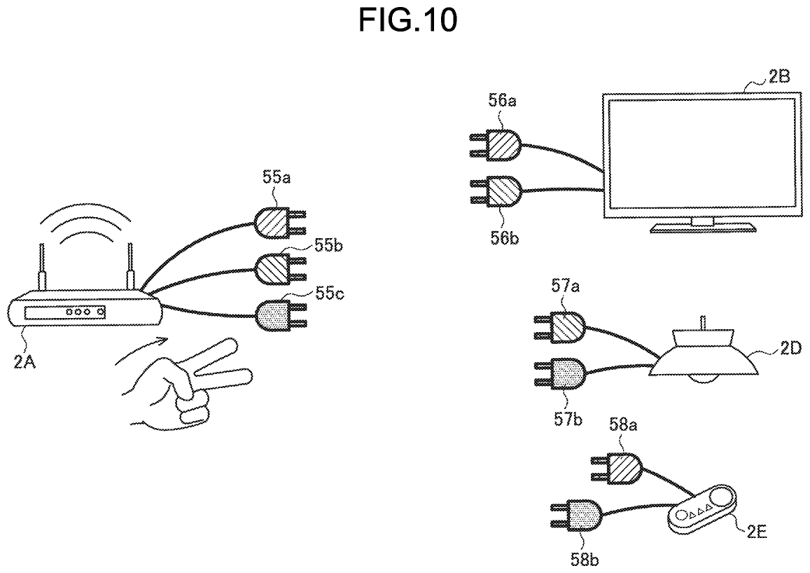

The AR cable image 53 to be caused to appear may be in different display modes depending on the type of the communication scheme as illustrated in FIG. 10 and FIG. 11. Due to this, the user can intuitively grasp the wireless appliance 2n that can be connected to the wireless appliance 2 as the target and the communication scheme that can be used therefor.

(Disconnection Gesture)

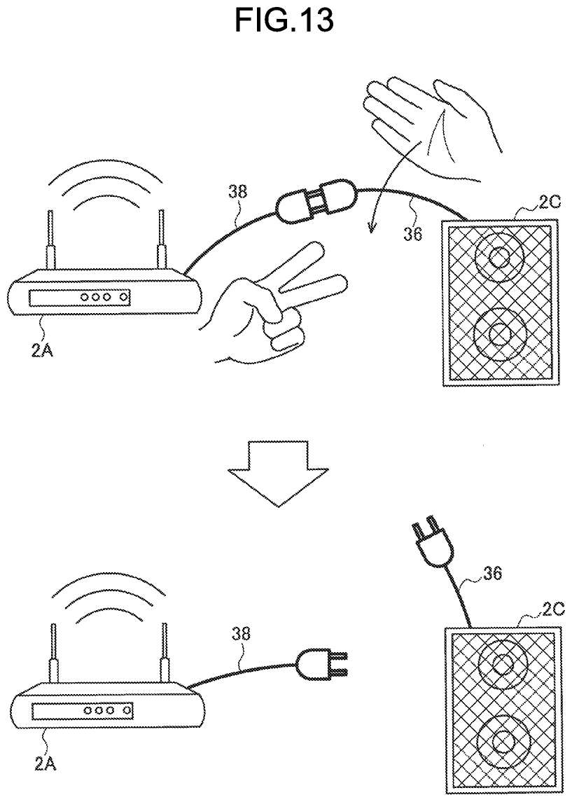

FIG. 13 is a diagram illustrating an example of the disconnection gesture according to the present embodiment. As illustrated in FIG. 13, for example, the disconnection gesture may be a predetermined gesture for the AR cable images 36 and 38 indicating the connected state. Specifically, as illustrated in FIG. 13, the connection gesture may be a motion of designating a target by one hand and disconnecting the AR cable image 36 from the AR cable image 38 by the other hand. The target may be designated by holding a hand near the target (the wireless appliance 2A or the AR cable images 38 and 36) with a predetermined motion of the hand and a predetermined shape of the finger (in this case, in a state in which two fingers are raised).

When detecting a disconnection gesture operation as illustrated in an upper row of FIG. 13, the information processing terminal 1 performs processing of disconnecting communication connection between the wireless appliance 2A as the target and the wireless appliance 2C. When the disconnection processing is performed, as illustrated in a lower row of FIG. 13, the information processing terminal 1 displays the AR cable image 38 of the wireless appliance 2A and the AR cable image 36 of the wireless appliance 2C to be separated from each other to enable the user to intuitively grasp the fact that the disconnection processing ends. Alternatively, in a case of performing the disconnection processing, the information processing terminal 1 may cause the AR cable images 36 and 38 not to be displayed. The information processing terminal 1 may perform display control for dividing the AR cable images 36 and 38 in accordance with the disconnection gesture operation performed by the user. In a case in which it takes much time for the disconnection processing, the information processing terminal 1 may superimpose and display text such as “disconnecting”, an icon image indicating a disconnecting state, and the like on the AR cable images 36 and 38. The information processing terminal 1 may also generate a sound, vibration, an image, blinking, and the like as feedback at the time when the disconnection operation is detected or disconnection is completed.

The disconnection operation may be commanded by designating a target to be disconnected by a voice command, for example, an uttered voice such as “disconnect the Wi-Fi master unit from the speaker” or “cancel all connections”. The disconnection operation may also be a combination of a gesture and a voice command. For example, in a case in which the user holds his/her left hand and right hand near the respective wireless appliances 2 as targets and utters a voice command such as “disconnect” or “cancel the connection”, the information processing terminal 1 performs processing of disconnecting (canceling) a wireless connection between the wireless appliances 2 as the targets.

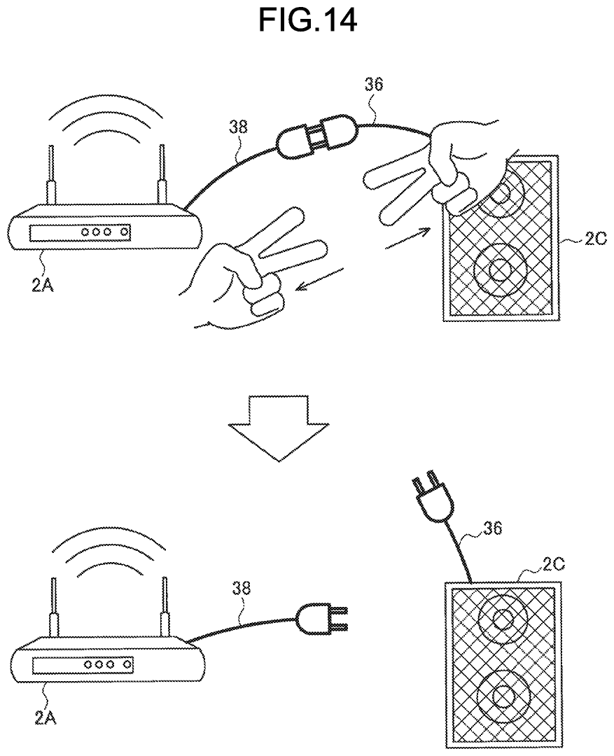

FIG. 14 is a diagram illustrating another example of the disconnection gesture according to the present embodiment. As illustrated in FIG. 14, the disconnection gesture operation according to the present embodiment may be, for example, a gesture of designating the AR cable images 38 and 36 as targets by respective hands, and moving the hands to be away from each other.

The connection operation and the disconnection operation according to the present embodiment have been specifically described above.

The information processing terminal 1 then ends the AR cable display mode (Step S133). An end trigger for the AR cable display mode may be an end gesture, a voice command, a combination of a gesture and a voice command, or a timeout. The end gesture may be the same as the activation gesture for the AR cable display mode. In a case of a connection management controllable mode, the information processing terminal 1 may end display in a case in which the connection processing or the disconnection processing of the wireless appliance 2 is performed in accordance with a user operation.

An example of the operation processing according to the present embodiment is described above. The operation processing illustrated in FIG. 4 is merely an example, and the present disclosure is not limited to the example illustrated in FIG. 4. For example, the present disclosure is not limited to the order of the steps illustrated in FIG. 4. At least some of the steps may be performed in parallel, or may be performed in the reverse order. For example, the processing at Steps S103 to S106 and the processing at Step S109 may be performed in parallel, or may be performed in the reverse order.

All pieces of the processing illustrated in FIG. 4 are not necessarily performed. For example, in a case in which pieces of the display processing at Steps S109 to S112 are skipped, and detection of the connection gesture at Step S121 or detection of the disconnection gesture at Step S127 is performed, the AR cable image indicating a link between the wireless appliances may be displayed. For example, pieces of the processing at Steps S115 to S118 may be included in the connection processing at Step S124 or the disconnection processing at Step S130 to be performed.

All pieces of the processing illustrated in FIG. 4 are not necessarily performed by a single device.

The pieces of the processing illustrated in FIG. 4 are not necessarily performed in temporal sequence. For example, pieces of the processing at Steps S103 to S106 may be immediately performed each time a new wireless appliance is detected while pieces of the processing at Steps S109 to S133 are performed.

### 4. COMPLEMENT

### 4-1. Application Example

In the information processing system according to the present embodiment described above, the virtual object indicating the connection state between the wireless appliances is displayed assuming AR, but the present embodiment is not limited thereto. For example, display or connection management of a virtual object indicating a connection state between virtual objects may be performed by virtual reality (VR).

The information processing terminal 1 is not limited to a wearable device as illustrated in FIG. 2, and may be a mobile device such as a smartphone, for example. When a mobile device is held near a wireless appliance in the real space, a through image is displayed on a display unit, and a virtual object indicating a link of communication connection between wireless appliances reflected in the through image (the AR cable images 30 to 37 and the like illustrated in FIG. 6 and FIG. 7) is displayed at the same time. Connection management (connection processing, disconnection processing) may be enabled to be intuitively performed by performing a predetermined touch operation, tap operation, double-tap operation, swipe operation, or drag operation on the virtual object displayed on the display unit.

The image indicating the connection state between the wireless appliances present in the real space is not limited to the virtual object, and may be projected by a projector, or displayed on a display disposed on a table, a floor, a wall, and the like on which the wireless appliance is placed, for example.

### 4-2. Hardware Configuration

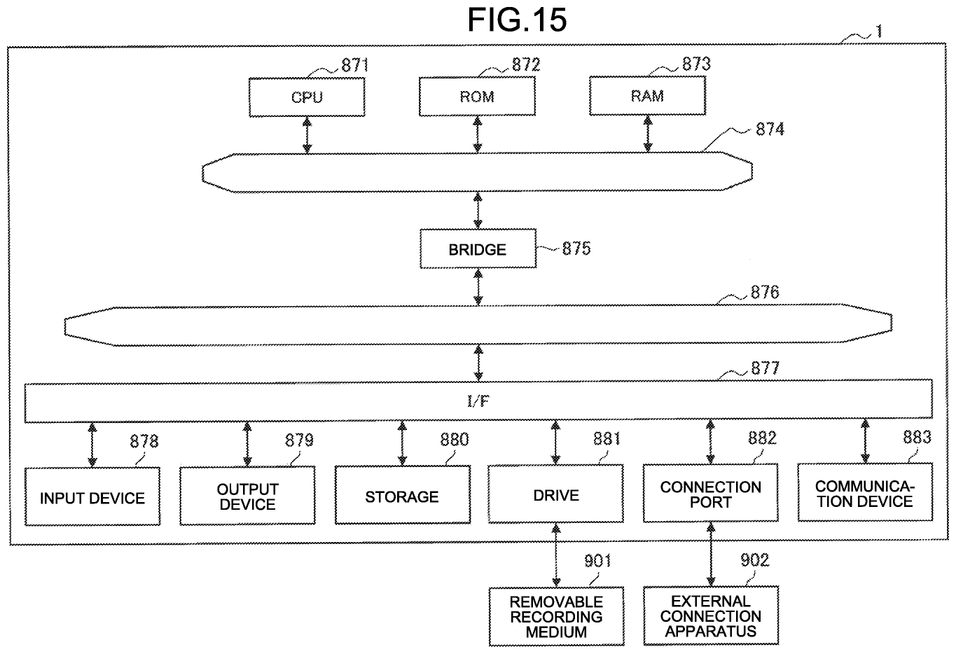

Next, the following describes a hardware configuration example of the information processing terminal 1 according to one embodiment of the present disclosure. FIG. 15 is a block diagram illustrating a hardware configuration example of the information processing terminal 1 according to one embodiment of the present disclosure. In FIG. 15, the information processing terminal 1 includes, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. The hardware configuration described herein is merely an example, and part of constituent elements thereof may be omitted. The hardware configuration may further include a constituent element other than the constituent elements described herein.

(CPU 871)

The CPU 871 functions, for example, as an arithmetic processing device or a control device, and controls the entire or part of operations of the constituent elements based on various computer programs recorded in the ROM 872, the RAM 873, the storage 880, or a removable recording medium 901.

Specifically, the CPU 871 implements the operations of the control unit 12 in the information processing terminal 1.

(ROM 872, RAM 873)

The ROM 872 is a unit that stores a computer program read by the CPU 871, data used for an arithmetic operation, and the like. For example, the RAM 873 temporarily or permanently stores a computer program read by the CPU 871, various parameters that vary as appropriate at the time when the computer program is executed, and the like.

(Host Bus 874, Bridge 875, External Bus 876, Interface 877)

The CPU 871, the ROM 872, and the RAM 873 are connected to each other via the host bus 874 that can perform fast data transmission, for example. On the other hand, the host bus 874 is connected, via the bridge 875, to the external bus 876 the data transmission speed of which is relatively low, for example. The external bus 876 is connected to various constituent elements via the interface 877.

(Input Device 878)

As the input device 878, for example, a mouse, a keyboard, a touch panel, a button, a switch, and a lever are used. Additionally, as the input device 878, a remote controller (hereinafter, referred to as a remote control) may be used, the remote control being able to transmit a control signal by utilizing infrared rays or other radio waves. The input device 878 may also include a voice input device such as a microphone.

(Output Device 879)

The output device 879 is, for example, a device that can visually or aurally notifies the user of acquired information, that is, a display device such as a Cathode Ray Tube (CRT), an LCD, or an organic EL, an audio output device such as a speaker and a headphone, a printer, a cellular telephone, a facsimile, or the like. The output device 879 according to the present disclosure includes various vibration devices that can output tactile stimulation.

(Storage 880)

The storage 880 is a device for storing various kinds of data. As the storage 880, for example, used are magnetic storage device such as a hard disk drive (HDD), a semiconductor storage device, an optical storage device, a magneto-optical storage device, or the like.

(Drive 881)

The drive 881 is, for example, a device that reads out information recorded in the removable recording medium 901 such as a magnetic disc, an optical disc, a magneto-optical disc, or a semiconductor memory, or writes information into the removable recording medium 901.

(Removable Recording Medium 901)

The removable recording medium 901 is, for example, a DVD medium, a Blu-ray (registered trademark) medium, an HD DVD medium, various kinds of semiconductor storage media, or the like. Obviously, for example, the removable recording medium 901 may be an IC card on which a contactless IC chip is mounted, an electronic appliance, or the like.

(Connection Port 882)

The connection port 882 is, for example, a port for connecting an external connection appliance 902 such as a Universal Serial Bus (USB) port, an IEEE1394 port, a Small Computer System Interface (SCSI), an RS-232C port, or an optical audio terminal.

(External Connection Appliance 902)

The external connection appliance 902 is, for example, a printer, a portable music player, a digital camera, a digital video camera, an IC recorder, or the like. The external connection appliance 902 is also the wireless appliance 2 and the like illustrated in FIG. 1.

(Communication Device 883)

The communication device 883 is a communication device for making a connection to a network, and examples thereof include a communication card for a wired or wireless LAN, Wi-Fi (registered trademark), Bluetooth (registered trademark), or Wireless USB (WUSB), a router for optical communication, a router for Asymmetric Digital Subscriber Line (ADSL), a modem for various kinds of communication, or the like.

### 5. CONCLUSION

The preferred embodiment of the present disclosure has been described above in detail with reference to the attached drawings, but the present technique is not limited thereto. A person ordinarily skilled in the art of the present disclosure may obviously conceive various examples of variations or modifications without departing from the technical idea disclosed in CLAIMS, and these variations or modifications are obviously encompassed by the technical scope of the present disclosure.

For example, it is possible to create a computer program for causing hardware such as a CPU, a ROM, and a RAM incorporated in the information processing terminal 1 described above to function as the information processing terminal 1. Additionally, a computer-readable storage medium storing the computer program is provided.

The effects described in the present description are provided as merely explanations or examples, and are not provided as limitation. That is, the technique according to the present disclosure can exhibit other effects that are obviously conceivable by those skilled in the art based on the description herein in addition to or in place of the effects described above.

The present technique can also employ the following configurations.

(1)

An information processing device comprising: a control unit configured to perform control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

(2)

The information processing device according to (1), wherein

the positional information is three-dimensional position information indicating a position in a space, and

the control unit performs control for displaying, in a case in which the first wireless appliance is connected to the second wireless appliance, the first virtual object that links a three-dimensional position of the first wireless appliance with a three-dimensional position of the second wireless appliance.

(3)

The information processing device according to (2), wherein the first virtual object is a line-shaped display image that links the first wireless appliance with the second wireless appliance.

(4)

The information processing device according to (3), wherein the first virtual object includes a virtual cable image of the first wireless appliance and a virtual cable image of the second wireless appliance.

(5)

The information processing device according to any one of (2) to (4), wherein

the control unit
detects a disconnection operation performed by a user for disconnecting the connection between the first wireless appliance and the second wireless appliance, and
performs disconnection processing for disconnecting the connection between the first wireless appliance and the second wireless appliance after detecting the disconnection operation.
   (6)

The information processing device according to (5), wherein the disconnection operation performed by the user is an operation by gesture or voice.

(7)

The information processing device according to (6), wherein a motion of a hand that disconnects the first virtual object linking the first wireless appliance with the second wireless appliance is detected as the gesture.

(8)

The information processing device according to any one of (1) to (7), wherein

the control unit
acquires positional information of a third wireless appliance in a case of detecting the third wireless appliance that is not connected to the first wireless appliance, and
performs control for displaying a second virtual object indicating a non-connected state with respect to the first wireless appliance at a position of the third wireless appliance.
   (9)

The information processing device according to (8), wherein

the control unit
detects a connection operation performed by a user for connecting the first wireless appliance with the third wireless appliance, and
performs connection processing for connecting the first wireless appliance with the third wireless appliance after detecting the connection operation.
   (10)

The information processing device according to (9), wherein the connection operation performed by the user is an operation by gesture or voice.

(11)

The information processing device according to (10), wherein the gesture is at least an operation for a third virtual object indicating a non-connected state displayed at the position of the first wireless appliance, or the second virtual object indicating a non-connected state displayed at a position of the third wireless appliance.

(12)

The information processing device according to (11), wherein the second virtual object and the third virtual object are virtual cable images having different display modes for respective wireless communication schemes.

(13)

The information processing device according to any one of (9) to (12), wherein the control unit performs connection processing using a wireless communication scheme that is different depending on the connection operation.

(14)

The information processing device according to any one of (1) to (13), wherein

the control unit
displays an image indicating a fourth wireless appliance present in another space,
acquires connection information about a connection between the first wireless appliance and the fourth wireless appliance, and
performs control for displaying a fourth virtual object that links a three-dimensional position of the first wireless appliance with a display position of the image indicating the fourth wireless appliance in a case in which the first wireless appliance is connected to the fourth wireless appliance.
   (15)

An information processing method performed by a processor, the information processing method comprising:

performing control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

(16)

A computer program for causing a computer to function as a control unit configured to perform control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

### REFERENCE SIGNS LIST

1 Information processing terminal
(2A to 2F) Wireless appliance
11 Sensor unit
12 Control unit
13 Display unit
14 Speaker
15 Communication unit
16 Operation input unit
17 Storage unit
110 Outward camera
111 Inward camera
112 Microphone
113 Gyro sensor
114 Acceleration sensor
115 Azimuth sensor
116 Position measuring unit
117 Biosensor
120 Wireless appliance association processing unit
122 User operation recognition unit
124 Connection state acquisition unit
126 Connection state display processing unit
128 Connection management unit
30 to 38, 55 to 58 AR cable image

1. An information processing device comprising:
a control unit configured to perform control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

2. The information processing device according to claim 1, wherein
the positional information is three-dimensional position information indicating a position in a space, and
the control unit performs control for displaying, in a case in which the first wireless appliance is connected to the second wireless appliance, the first virtual object that links a three-dimensional position of the first wireless appliance with a three-dimensional position of the second wireless appliance.

3. The information processing device according to claim 2, wherein the first virtual object is a line-shaped display image that links the first wireless appliance with the second wireless appliance.

4. The information processing device according to claim 3, wherein the first virtual object includes a virtual cable image of the first wireless appliance and a virtual cable image of the second wireless appliance.

5. The information processing device according to claim 2, wherein
the control unit
detects a disconnection operation performed by a user for disconnecting the connection between the first wireless appliance and the second wireless appliance, and
performs disconnection processing for disconnecting the connection between the first wireless appliance and the second wireless appliance after detecting the disconnection operation.

6. The information processing device according to claim 5, wherein the disconnection operation performed by the user is an operation by gesture or voice.

7. The information processing device according to claim 6, wherein a motion of a hand that disconnects the first virtual object linking the first wireless appliance with the second wireless appliance is detected as the gesture.

8. The information processing device according to claim 1, wherein
the control unit
acquires positional information of a third wireless appliance in a case of detecting the third wireless appliance that is not connected to the first wireless appliance, and
performs control for displaying a second virtual object indicating a non-connected state with respect to the first wireless appliance at a position of the third wireless appliance.

9. The information processing device according to claim 8, wherein
the control unit
detects a connection operation performed by a user for connecting the first wireless appliance with the third wireless appliance, and
performs connection processing for connecting the first wireless appliance with the third wireless appliance after detecting the connection operation.

10. The information processing device according to claim 9, wherein the connection operation performed by the user is an operation by gesture or voice.

11. The information processing device according to claim 10, wherein the gesture is at least an operation for a third virtual object indicating a non-connected state displayed at the position of the first wireless appliance, or the second virtual object indicating a non-connected state displayed at a position of the third wireless appliance.

12. The information processing device according to claim 11, wherein the second virtual object and the third virtual object are virtual cable images having different display modes for respective wireless communication schemes.

13. The information processing device according to claim 9, wherein the control unit performs connection processing using a wireless communication scheme that is different depending on the connection operation.

14. The information processing device according to claim 1, wherein
the control unit
displays an image indicating a fourth wireless appliance present in another space,
acquires connection information about a connection between the first wireless appliance and the fourth wireless appliance, and
performs control for displaying a fourth virtual object that links a three-dimensional position of the first wireless appliance with a display position of the image indicating the fourth wireless appliance in a case in which the first wireless appliance is connected to the fourth wireless appliance.

15. An information processing method performed by a processor, the information processing method comprising:
performing control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.

16. A computer program for causing a computer to function as a control unit configured to perform control for displaying, on a display unit, a first virtual object indicating a link between a first wireless appliance and a second wireless appliance based on connection information about a connection between the first wireless appliance and the second wireless appliance, and positional information of the first wireless appliance and positional information of the second wireless appliance.
